(19) United States
(12) Patent Application Publication
(10) Pub. No.: US 2011/0302355 A1
(43) Pub. Date: Dec. 8, 2011

(54) MAPPING AND WRITTING METHOD IN MEMORY DEVICE WITH MULTIPLE MEMORY CHIPS

(75) Inventor: Gene Lin, Hsinchu City (TW)

(73) Assignee: SOLID STATE SYSTEM CO., LTD., Hsinchu (TW)

(21) Appl. No.: 12/793,701

(22) Filed: Jun. 4, 2010

(51) Int. Cl. G06F 12/02; G06F 12/00

(52) U.S. Cl. 711/103; 711/202; 711/E12.001; 711/E12.008

(57) ABSTRACT

The invention is directed to a mapping method in a memory device with a plurality of memory chips in a sequence of 0 to K, K≧1. Each of the memory chips has a plurality of data blocks. The mapping method includes setting a block sequence number “(K+1)*n” to the (n+1)^{th} data block of the memory chip K, wherein n is a positive integer greater than or equal to 0. Based on the mapping method, a writing method is also provided.

### BACKGROUND OF THE INVENTION

1. Field of Invention

The present invention relates to access operation for a memory device with multiple memory chips.

2. Description of Related Art

Nonvolatile memory chips, which include nonvolatile memory arrays, have various applications for storing digital information. One such application is capable of storing a large amount of digital information used by digital cameras, as replacements for hard disk within a personal computer (PC) and so forth. Nonvolatile memory arrays are comprised of various types of memory cells, such as NOR, NAND and other types of structures known to those of ordinary skill in the art. One of the characteristics of nonvolatile memory is that the stored information still remains while power is disconnected or disrupted.

FIG. 1 is a block diagram, schematically illustrating architecture of flash memory card. In FIG. 1, the host end 100 can access the data stored in a flash disk 102, in which the flash disk (memory device) 102 includes a controller 104 and a memory unit 106. The memory unit 106 may include multiple memory chips. In access operation, the host end 100 usually accesses the data in the memory unit 106 via the control unit 104 at the requested address. In addition to communicating with the host, the control unit 104 also takes responsibility of managing the memory unit 106 via the memory interface.

FIG. 2 is a mapping architecture maintained by the control unit. The host side, includes a plurality of logical blocks. Each of the logical blocks can be addressed by the host. Namely, the host can access all the logical space, including logical block 0, logical block 1, . . . , and logical block N. The physical space including physical block 0, physical block 1, . . . and physical block N is used to store the actual information. The logical space should be mapped to the physical space.

When multiple chips are included in the memory unit, the data written by the host are alternatively written into the memory chips by taking pages as the storage units. FIG. 3 is a drawing, schematically illustrating the conventional writing operation to write data into two memory chips. In FIG. 3, two memory chips 108 and 110, indicated by chip 0 and chip 1, are taken as an example for descriptions. Each of the chip 0 and chip 1 has multiple data blocks. Each data block has, for example, 64 or 128 pages for storing data, or even more pages. The page is a smaller storage unit, having a number of memory cells arranged in an array. When data are to be written to the two memory chips, the data are also configured into several pages to map to the chips 0 and chip 1. Taking one block with 128 pages as an example, a set of data with a size of 256 pages is configured into LogicalPage_D 0 (LP_D 0), LogicalPage_D 1 (LP_D 1), . . . , LogicalPage_D 127 (LP_D 127), . . . and LogicalPage_D 255 (LP_D 255), which are alternatively written to the chip 0 and chip 1. In other words, LP_D 0 is stored in chip 0 and LP_D 1 is stored in chip 1. As a result, chip 0 stores the even pages. Chip 1 stores the odd pages.

In recent development of flash memory, the memory cell is not just storing one bit of data for single-level cell (SLC) memory cell. The memory cell called multi-level cell (MLC) has been very popular, in which one memory cell can store multiple bits of data. The MLC memory cell takes longer time for a writing operation than the SLC memory cell takes. In the conventional manner as shown in FIG. 3, when the memory device having two memory chips, writing data alternatively into chip 0 and chip 1 by page size unit is adapted to save the total programming time. In the present invention, another data configuration and mapping method with the unit of block size is introduced.

### SUMMARY

The invention is directed to method of writing or mapping on the memory device with multiple memory chips, and the operation time can be reduced.

The invention provides a mapping method in a memory device with a plurality of memory chips in a sequence of 0 to K, K≧1. Each of the memory chips has a plurality of data blocks. The mapping method includes setting a block sequence number “(K+1)*n” to the (n+1)^{th} data block of the memory chip K, wherein n is a positive integer greater than or equal to 0.

The invention provides a mapping method in a memory device with a plurality of memory chips in a sequence of 0 to K, K≧1, wherein each of the memory chips has a plurality of data blocks, and each of the data blocks has a plurality of pages for storing data. The mapping method includes setting the data blocks in the memory chips by a block sequence recurrently from the memory chip 0 to the memory chip K; and setting a consecutive page sequence for the pages in each of the data blocks and the consecutive pages sequences between the two consecutive data blocks are also consecutive.

The invention provides a writing method in a memory device with multiple memory chips, wherein each of the memory chips has a plurality of data blocks for storing data. The writing method includes receiving a set of consecutive data from a host, wherein the set of consecutive data is to be stored to the memory device, and writing the set of consecutive data into correspondent data blocks of the memory chips. Two consecutive data blocks of the set of consecutive data are written into two of the memory chips of the memory device.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram, schematically illustrating architecture of flash memory card.

FIG. 2 is a mapping architecture maintained by the control unit. The host side accesses the memory unit by logical block address.

FIG. 3 is a drawing, schematically illustrating the data structure of the conventional writing operation of the memory device with two memory chips.

FIG. 4 is a drawing, schematically illustrating a writing operation from the host to the memory device with multiple memory chips.

FIG. 5 is a drawing, schematically illustrating the data block structure in the memory chips, according to an embodiment of the invention.

FIG. 6 is a drawing, schematically illustrating the mapping relationship in the unit of page size.

FIG. 7 is a drawing, schematically illustrating the memory device with three memory chips, according to an embodiment of the invention.

FIG. 8 is a drawing, schematically illustrating the memory device with eight memory chips, according to an embodiment of the invention.

FIGS. 9-13 are the signal trains in writing operation for the memory device with eight memory chips, according to embodiments of the invention.

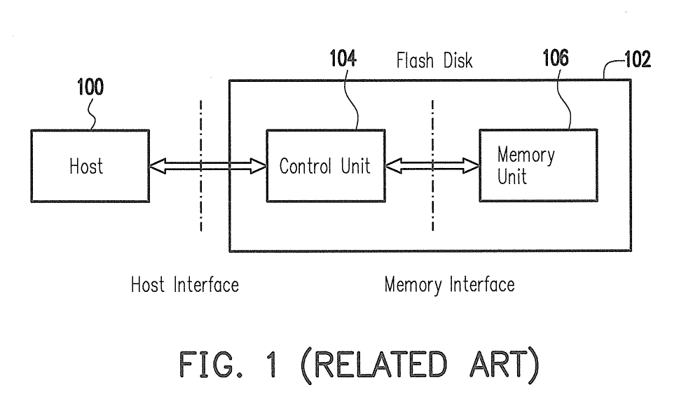

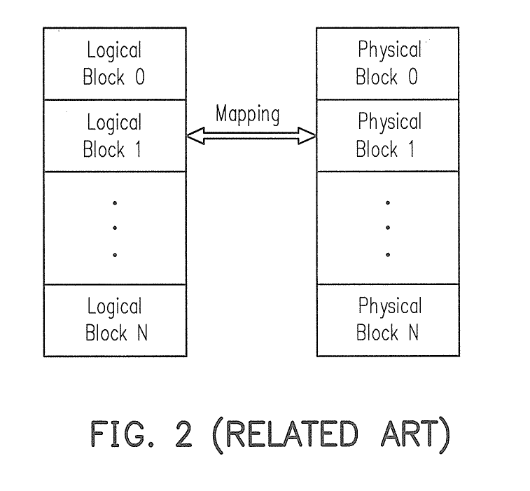

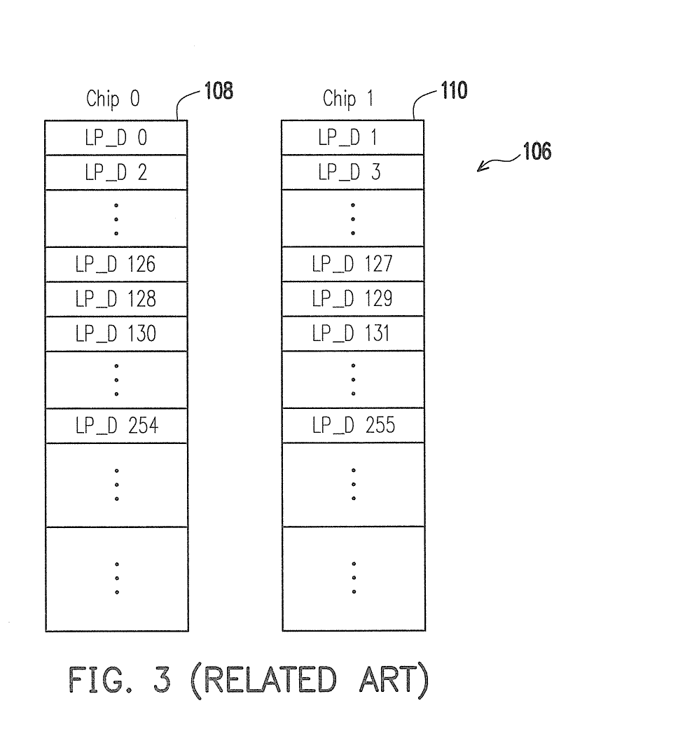

### DESCRIPTION OF THE PREFERRED EMBODIMENTS

In the invention, a data mapping structure from the logical block to the physical block is arranged in a novel manner so that the waiting idle time can be reduced. Several embodiments are provided in the following descriptions. However, the invention is not limited to the provided embodiments.

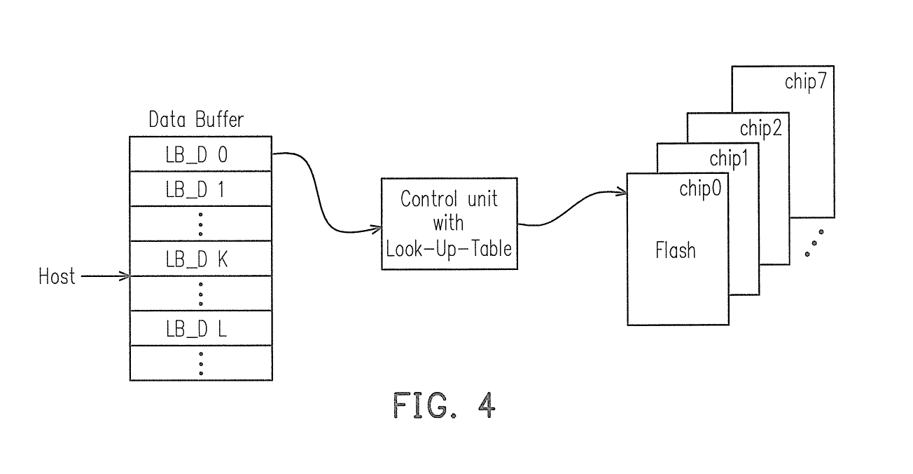

FIG. 4 is a drawing, schematically illustrating a writing operation from the host to the memory device with multiple memory chips. The control unit maintains a Look-Up-Table which allows the host to access the entire memory space. When the host writes a set of consecutive data to the memory device, the data are cached in cache buffers with the unit size of one data block, as for example indicated as LB 0, LB 1, . . . , LB N. When each block-sized cache unit is fully written, the data are then written to the corresponding physical block in the memory device, such as flash memory with chip 0, chip 1, . . . , chip 7. Each chip separately receives one block-sized data in each time. When the data are not finished written, the chip sequence is cycle. In further detail, at the moment of writing data to flash, if the cache unit is not fully written, the data of the unwritten part will be filled with the data read back from the correspondent location of the memory device. And then the data are written back to the correspondent block location in the memory device.

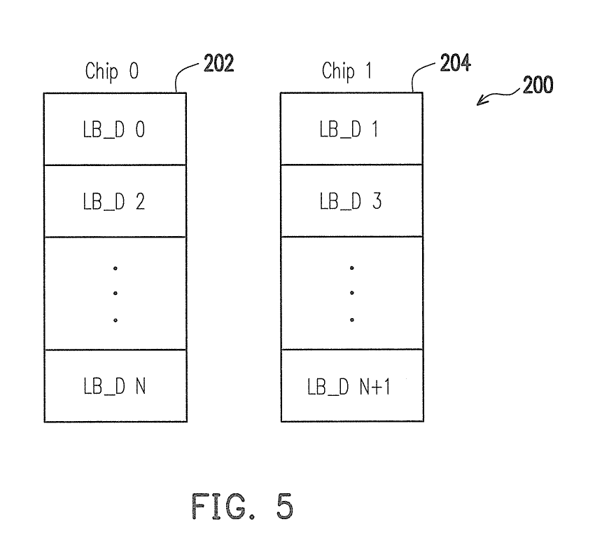

FIG. 5 is a drawing, schematically illustrating the data block structure in the memory chips, according to an embodiment of the invention. In FIG. 5, taking for an example, the memory device 200 has two chips, chips 202 and 204, which are also indicated as chip 0 and chip 1, each chip having multiple data blocks. The data blocks are configured into a block sequence, alternatively and recurrently distributed in the memory chips 202 and 204. In other words, the first data block of the chip 202 is assigned as LogicalBlock_Data 0 (LB_D 0) and the first data block of the chip 204 is assigned as LogicalBlock_Data 1 (LB_D 1). Then, the second data block of the chip 202 is assigned as LB_D 2 and the second data block of the chip 204 is assigned as LB_D 3. The same manner is applied throughout the whole memory space. The last data block of the chip 202 is assigned as LB_D N and the last data block of the chip 204 is assigned as LB_D N+1. In other words, the data in consecutive blocks are written into the consecutive blocks in the two memory chips 202 and 204.

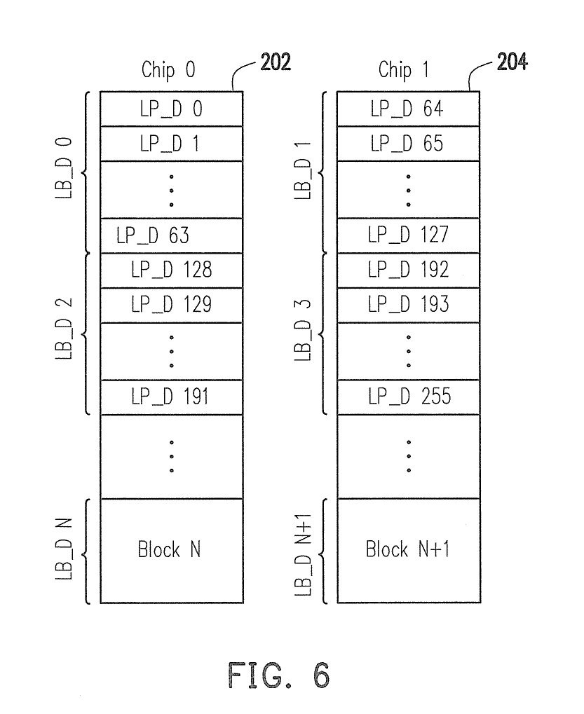

In more details, each data block has multiple pages. FIG. 6 is a drawing, schematically illustrating the mapping relationship in the unit of page size. In FIG. 6, taking the example that one data block has 64 page sections, the LB_D 0 contains 64 page sections, indicted by LP_D 0, LP_D 1, . . . , LP_D 63, in which the page sections are consecutive for the data block itself. When the LB_D 0 finishes in space, the LP_D 64 is then mapped to the LB_D 1 in chip 204. Likewise, the second page of the LB_D 0 is assigned as LP_D 65. Following the consecutive page sequence, the last page section of the LB_D 1 is assigned as LP_D 127. The LP_D 128 is then mapped to the first page section of the LB_D 2. Likewise, the page sections of the LB_D 2 are assigned as LP_D 128 to LP_D 191 in the chip 202. The page sections of the LB_D 3 of chip 204 are assigned as LP_D 192 to LP_D 255. The same manner is continuous to the last data blocks LB_D N and LB_D N+1. The total available block number for each flash chip could be different. Assigning two consecutive data blocks to two of the flash chips is the rule unless all the left un-assigned blocks are in same chip. It should be also noted that when the number of blocks to be written to the flash is more then the number of the chips, then a recycling sequence is set, by one block as a unit. For example, if the current available block is at the chip 3 of eight chips in total and the number of blocks of the buffered data to be written is 10 in sequence of block 1, . . . , block 10, then the assigning sequence of the blocks to the chips is chip 3, chip 4, . . . , chip 7, chip 0, chip 1, chip 2, chip 3, and chip 4. So, chip 3 and chip 4 have the consecutive block sequence. The consecutive two blocks, such as block 1 and block 2 are written to two of the chips, such as chip 3 and chip 4. However, in chip 3, the block sequence is not consecutive because chip 3 is written with buffered data of the block 1 and the block 9.

In the structure of the data configuration, the pages section in the data block is consecutive. In an example, the memory cells of the chip 204 at the LB_D 1 may be formed by the type of MLC memory cells, which takes longer programming time. Writing the LB_D 2 can be performed even when the programming of LB_D 1 in chip 1 is not finished yet. The memory chips are controlled by the pipeline mechanism, so that the two chips can work separately. In this situation, there is an overlapping operation time between chip 202 and the chip 204. The waiting idle time in convention manner can be reduced.

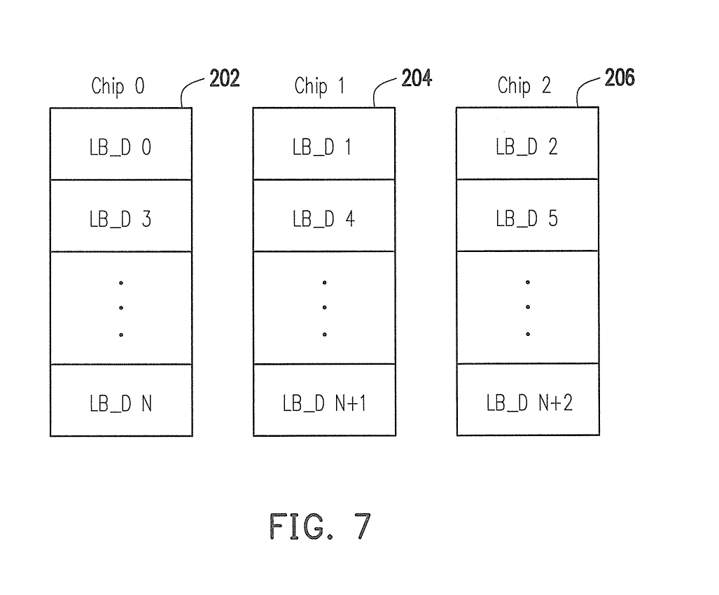

The memory device can have more memory chips. FIG. 7 is a drawing, schematically illustrating the memory device with three memory chips, according to an embodiment of the invention. In FIG. 7, an additional chip 206 is implemented with the two chips 202 and 204. Based on the same principle, the LB_D 0, the LB_D 1 and the LB_D 2 are respectively mapped to the first data blocks of the three chips 202, 204, and 206. After finishing the first cycle, the data blocks of LB_D 3, the LB_D 4 and the LB_D 5 in second cycle are respectively written to the second blocks of the three chips 202, 204, and 206. Likewise, for the last cycle, the data blocks of the LB_D N, the LB_D N+1 and the LB_D N+2 in last cycle are respectively written to the last blocks of the three chips 202, 204, and 206.

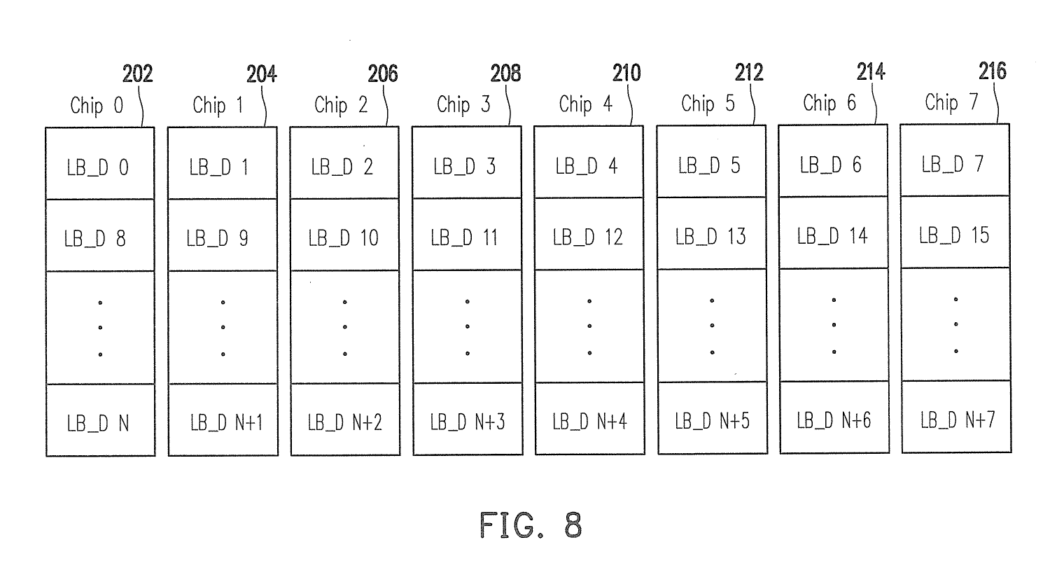

FIG. 8 is a drawing, schematically illustrating the memory device with eight memory chips, according to an embodiment of the invention. In FIG. 8, the additional memory chips 208, 210, 212, 214 and 216 are added. In this manner, the LB_D 0, the LB_D 1, the LB_D 2, . . . , the LB_D 7 are respectively mapped to the first data blocks of the eight chips 202-216. The LB_D 8, the LB_D 9, the LB_D 10, . . . , the LB_D 15 are respectively mapped to the second data blocks of the eight chips 202-216. Likewise, for the last cycle, the LB_D N, the LB_D N+1, the LB_D N+2, . . . , the LB_D N+7 are respectively mapped to the last data blocks of the eight chips 202-216.

In general, the block of the chips can be mapped in a sequence. For example, the data blocks for the memory chip 0 can be set by a block sequence of (K+1)*n, n=0, 1, 2 . . . , wherein a maximum of n is indicating a last data block and K+1 is the number of the memory chips in the memory device. For the example in FIG. 8, K is 7 for a memory device having eight memory chips. In this example, the first block of chip 0 with n=0 has the block sequence of 0 (LB_D 0). The second block of chip 0 with n=1 has the block sequence of 8 (LB_D 8). Likewise, the data blocks for the memory chip 1 can be set by a block sequence of (K+1)*n+1. In the example of a memory device having eight memory chip, the first block of chip 1 with n=0 has a block sequence of 1 (LB_D 1). The second block of chip 1 having a block sequence of 9 (LB_D 9). The same assigning rule is applied to all blocks of all chips in the memory device. As can be noted, the writing manner can be referred to as a chip-by-chip with block-by-block manner. Chip-by-chip with block-by-block manner means that when a corresponding block in one chip is fully written, the next block of data to be stored is written into another data block in another consecutive chip.

Although the data block numbers in the foregoing examples are all the same, there is no such limitation. The total block number in each memory can be different and the LB_D sequence can be arranged in many other ways. The basic rule is to map two consecutive LB_D data blocks to two of the memory chips so that programming both LB_D data block of two separate chips can be performed simultaneously.

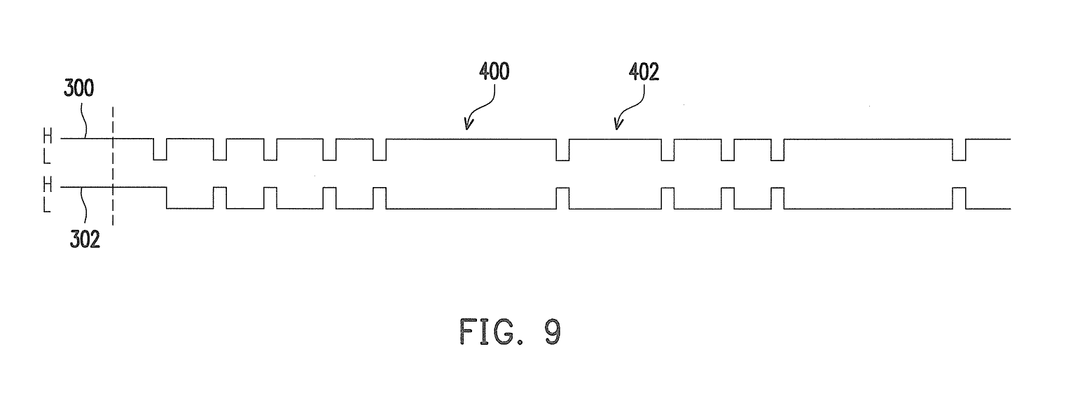

FIGS. 9-13 are the signal trains in writing operation for the memory device with eight memory chips, according to the embodiments of the invention. In FIG. 9, the signal 300 is the control signal for the chip 0. When signal 300 is at low state, it performs loading data to the data block of the memory chip 0. After finishing data loading, the signal 302 is pulled from high state to low state. This means that chip 0 is under data programming stage and is not ready for data loading. Programming data can be time consuming as indicated at the regions 400 and 402 at the logic high state. The time for the regions 400 and 402 being longer may be resulting from different memory cell structure with longer programming time or different data size to be programmed, or other programming process needing longer time.

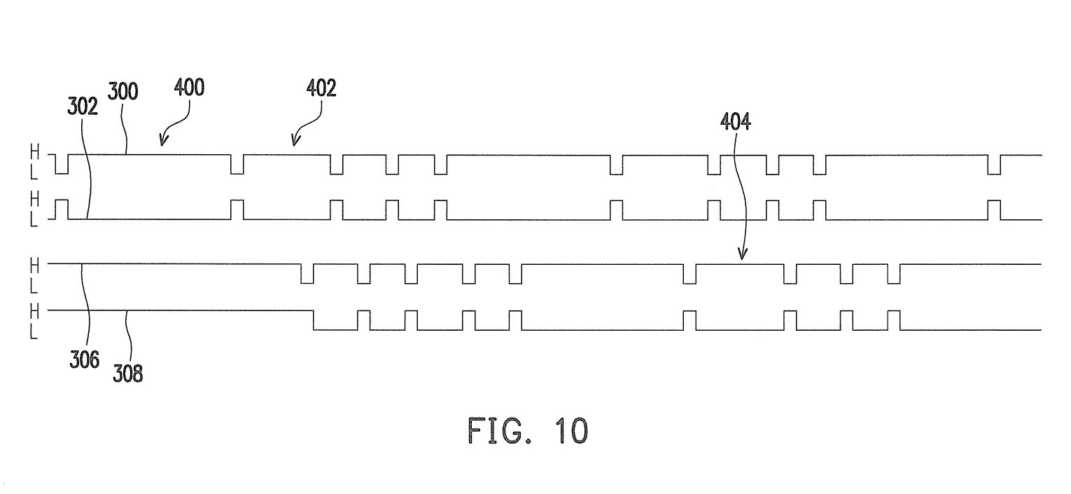

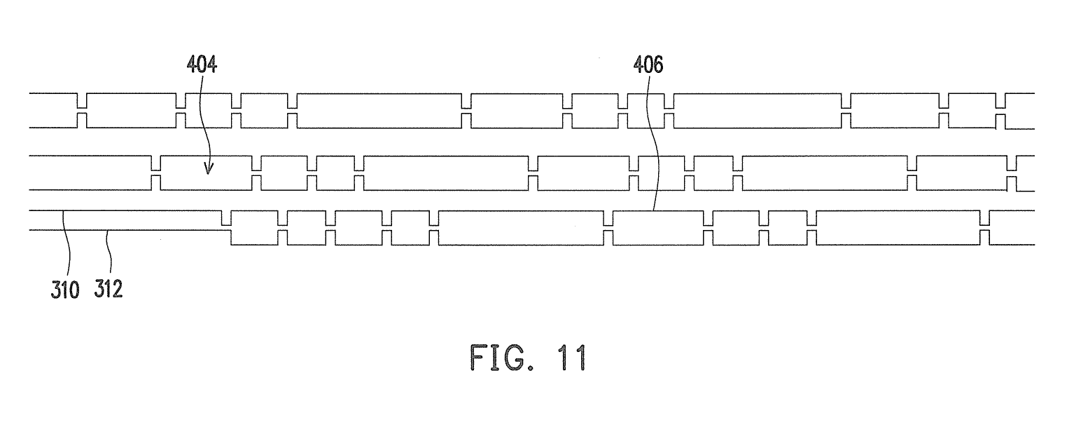

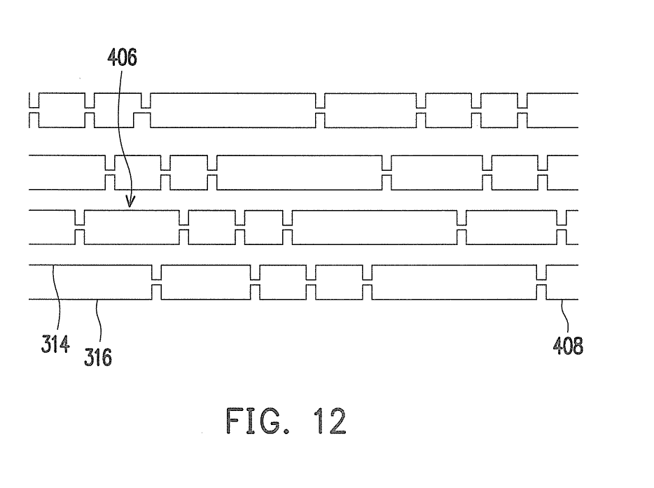

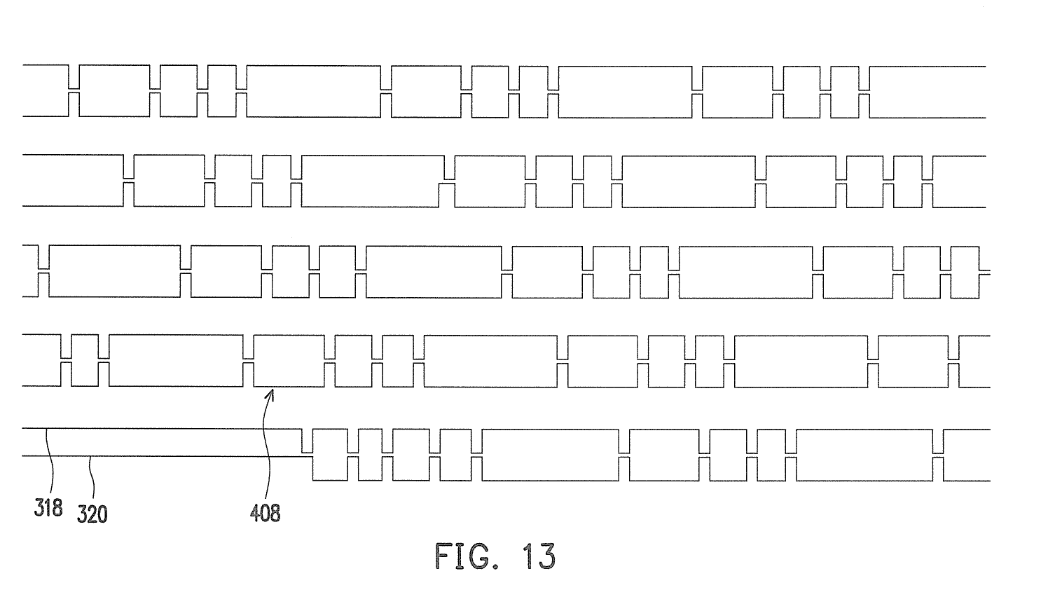

In FIG. 10, when the memory device contains two memory chips, chip 0 and chip 1. Loading data to chip 1 is controlled by the signal 306 and the signal 308 shows the busy state or ready state of the chip 1. Loading data to chip 1 and programming data in chip 1 can be performed while chip 0 is under programming data stage as indicated at the region 402. Likewise in FIG. 11, the data to be written to the chip 2 is shown by the signals 310 and 312, which can start at the region 404 in chip 1. In FIG. 12, likewise, the data to be written to the chip 3 as shown by the signals 314 and 316 can start at the region 406 in chip 2. In FIG. 13, likewise, the data to be written to the chip 4 as shown by the signals 318 and 320 can start at the region 408 in chip 3. The same principle is applied to the other chips 5-7. As can be seen in FIGS. 9-13, the pipeline mechanism can be applied. The more memory chips can program data at the same time, the more efficient the system will reach.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A mapping method in a memory device with a plurality of memory chips in a sequence of 0 to K, K≧1, wherein each of the memory chips has a plurality of data blocks, the mapping method comprising:
setting a block sequence number “(K+1)*n” to the (n+1)^{th} data block of the memory chip K, wherein n is a positive integer greater than or equal to 0.

2. The mapping method of claim 1, wherein a set of consecutive data received from a host are stored block by block following a sequence of the block sequence number.

3. The mapping method of claim 2, wherein two consecutive data blocks of the set of consecutive host data are written into two of the memory chips of the memory device.

4. The mapping method of claim 2, wherein the data blocks of the memory chips include a portion with a first-type block and a portion with a second-type block, wherein memory cells in the first-type block and the second-type block respectively have different programming times.

5. The mapping method of claim 1, wherein two consecutive data blocks of the set of consecutive host data are written into two of the memory chips of the memory device.

6. The mapping method of claim 1, wherein the data blocks of the memory chips include a portion with a first-type block and a portion with a second-type block, wherein memory cells in the first-type block and the second-type block respectively have different programming times.

7. A mapping method in a memory device with a plurality of memory chips in a sequence of 0 to K, K≧1, wherein each of the memory chips has a plurality of data blocks, the mapping method comprising:
setting the data blocks in the memory chips by a block sequence recurrently from the memory chip 0 to the memory chip K, wherein two consecutive data blocks of a set of host data are mapped to two of the memory chips of the memory device.

8. The mapping method of claim 7, wherein the data blocks of the memory chips include a portion with a first-type block and a portion with a second-type block, wherein memory cells in the first-type block and the second-type block respectively have different programming times.

9. A writing method in a memory device with multiple memory chips, wherein each of the memory chips has a plurality of data blocks for storing data, the writing method comprising:
receiving a set of consecutive data from a host, wherein the set of consecutive data is to be stored to the memory device;
writing the set of consecutive data into correspondent data blocks of the memory chips, wherein two consecutive data blocks of the set of consecutive data are written into two of the memory chips of the memory device.
